(19) United States
(12) Patent Application Publication
(10) Pub. No.: US 2012/0133349 A1
(43) Pub. Date: May 31, 2012

(54) MEASUREMENT CIRCUIT FOR BUCK CIRCUIT

(75) Inventors: SONG-LIN TONG, Shenzhen (CN); QI-YAN LUO, Shenzhen City (CN); PENG CHEN, Shenzhen City (CN)

(73) Assignees: HON HAI PRECISION INDUSTRY CO., LTD., Tu-Cheng (TW); HONG FU JIN PRECISION INDUSTRY (Shenzhen) CO., LTD., Shenzhen City (CN)

(21) Appl. No.: 12/962,562

(22) Filed: Dec. 7, 2010

(30) Foreign Application Priority Data
Nov. 26, 2010 (CN) 201010561042.4

(51) Int. Cl. G05F 1/618

(52) U.S. Cl. 323/285

(57) ABSTRACT

A measurement circuit for overload protection is applied in a buck circuit. The buck circuit includes a pulse width modulation (PWM) controller and a voltage output terminal. The measurement circuit includes a resistance setting circuit to connect different resistances to the PWM controller of the buck circuit. A switch circuit turns the measurement circuit on or off. A current collection circuit receives a voltage from the voltage output terminal of the buck circuit and transforms the received voltage to a current, and amplifies the transformed current and outputs the amplified current to the resistance setting circuit. The resistance setting circuit chooses a resistance through comparison of the amplified current with a preset current. A display unit displays the chosen resistance.

### BACKGROUND

1. Field of the Invention

The present disclosure relates to buck circuits, and particularly to a measurement circuit providing overload protection to a buck circuit.

2. Description of Related Art

Overload protection in a buck circuit is provided by connecting different resistors to the buck circuit manually, to generate optimal resistance for overload protection. However, the resistors must be individually soldered to corresponding locations, which is inconvenient and need extra man-hours.

### BRIEF DESCRIPTION OF THE DRAWINGS

Many aspects of the embodiments can be better understood with reference to the following drawing. The components in the drawing are not necessarily drawn to scale, the emphasis instead being placed upon clearly illustrating the principles of the present embodiments. Moreover, in the drawing, like reference numerals designate corresponding parts throughout the several views.

FIG. 1 is a circuit diagram for a buck circuit.

FIGS. 2 and 3 are a circuit diagram of a measurement circuit providing overload protection for a buck circuit in accordance with an exemplary embodiment of the present disclosure.

### DETAILED DESCRIPTION

The disclosure, including the drawings, is illustrated by way of example and not by limitation. It should be noted that references to “an” or “one” embodiment in this disclosure are not necessarily to the same embodiment, and such references mean at least one.

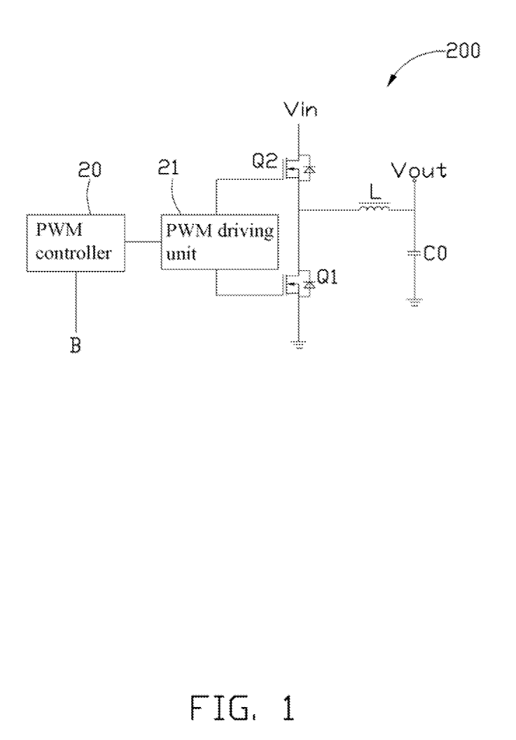

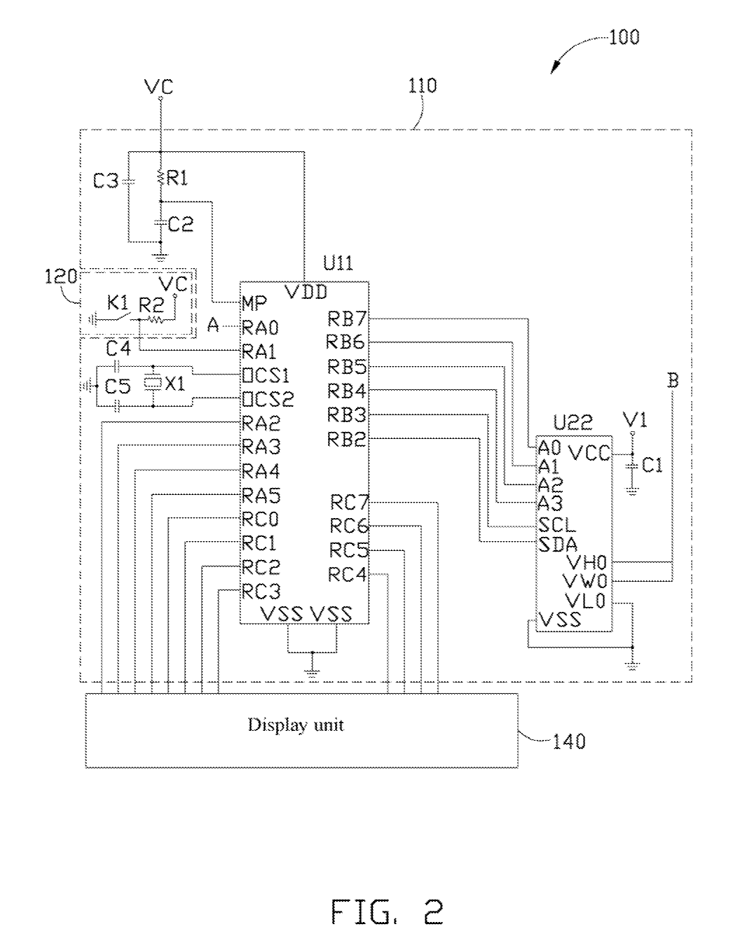

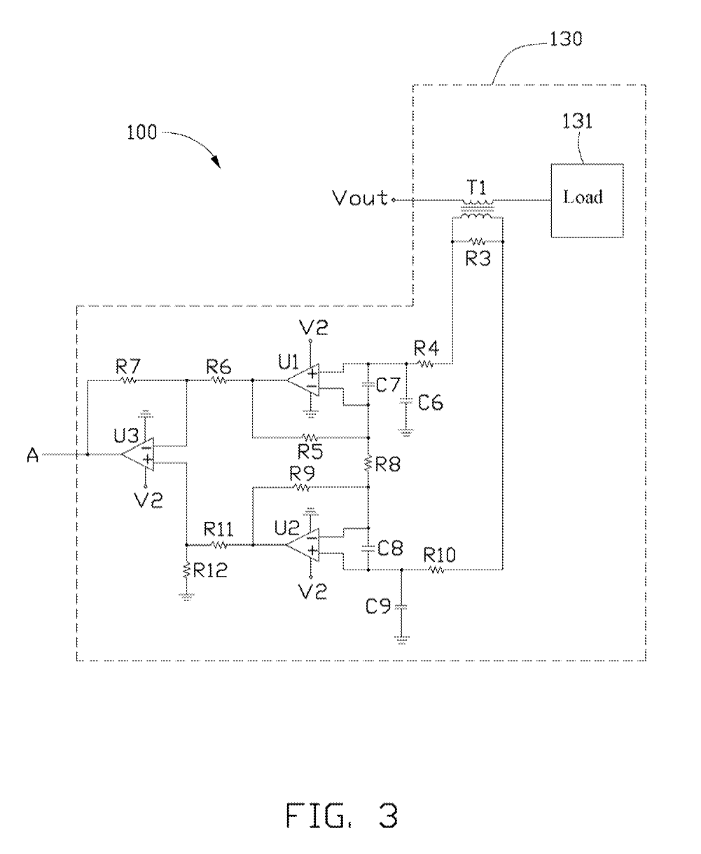

Referring to FIG. 1 to FIG. 3, a measurement circuit 100 is configured to provide overload protection for a buck circuit 200. The buck circuit 200 is mounted on a printed circuit board (not shown), and includes a pulse width modulation (PWM) controller 20, a PWM driving unit 21, two field effect transistors (FETs) Q1 and Q2, a voltage input terminal Vin, and a voltage output terminal Vout. The PWM controller 20 is connected to the measurement circuit 100. The PWM driving unit 21 is connected to the PWM controller 20 receiving a control signal from the PWM controller 20 and also connected to gates of the FETs Q1 and Q2 for outputting signals to turn the FETs Q1 and Q2 on or off. A drain of the FET Q2 is connected to the voltage input terminal Vin. A source of the FET Q1 is grounded. A drain of the FET Q1 is connected to a source of the FET Q2. The drain of the FET Q1 is also connected to one terminal of an inductor L and the other terminal of the inductor L is connected to one terminal of a capacitor C0. The other terminal of the capacitor C0 is grounded. The voltage output terminal Vout is connected to a node between the inductance L and the capacitor C0 for outputting a drive voltage to other elements (for example, central processor unit) and also connected to the measurement circuit 100.

The measurement circuit 100 in accordance with an exemplary embodiment includes a resistance setting circuit 110, a switch circuit 120, a current collection circuit 130, and a display unit 140. The resistance setting circuit 110 is configured to connect different resistors to the PWM controller 20 of the buck circuit 200. The switch circuit 120 is configured to turn the measurement circuit 100 on or off. The current collection circuit 130 is configured to receive voltage from the voltage output terminal Vout of the buck circuit 200 and convert the received voltage to current, and amplify the converted current and provide the amplified current to the resistance setting circuit 110. The resistance setting circuit 110 directs the display unit 140 to display the selected resistance.

The resistor setting circuit 110 includes a microcontroller U11, a digital regulation resistance U22, a resistor R1, five capacitors C1-C5, and a crystal oscillator X1. Input terminals A0-A3 of the digital regulation resistance U22 are connected to output terminals RB7-RB4 of the microcontroller U11. A clock terminal SCL of the digital regulation resistance U22 is connected to an output terminal RB3 of the microcontroller U11. A data terminal SDA of the digital regulation resistance U22 is connected to an output terminal RB2 of the microcontroller U11. A voltage terminal VCC of the digital regulation resistance U22 is connected to a power source V1 and connected to one terminal of the capacitor C1. The other terminal of the capacitor C1 is grounded. Output terminals VH0 and VW0 of the digital regulation resistance U22 are connected to the PWM controller 20. Ground terminals VSS and VL0 of the digital regulation resistance U22 are grounded. A voltage terminal VDD of the microcontroller U11 is connected to a power source VC, and connected to one terminal of the resistor R1. The other terminal of the resistor R1 is connected to one terminal of the capacitor C2. The other terminal of the capacitor C2 is grounded. One terminal of the capacitor C3 is connected to the voltage terminal VDD of the microcontroller U11 and the other terminal of the capacitor C3 is grounded. A voltage terminal MP of the microcontroller U11 is connected to a node between the resistor R1 and the capacitor C2. A clock terminal OCS1 of the microcontroller U11 is grounded through the capacitor C4. A clock terminal OCS2 of the microcontroller U11 is grounded through the capacitor C5. The crystal oscillator X1 is connected between the clock terminals OCS1 and OCS2 of the microcontroller U11. In one embodiment, microcontroller U11 is a PIC16F73 and digital regulation resistance U22 is X9241. The power source V1 is a 5 volt (V) power source.

The switch circuit 120 includes a resistor R2 and a switch K1. An input terminal RA1 of the microcontroller U11 is connected to the power source VC through the resistor R2 and also can be grounded through the switch K1.

The current collection circuit 130 includes a transformer T1, a load 131, amplifiers U1-U3, resistors R3-R12, and capacitors C6-C9. The load 131 is connected to the voltage output terminal Vout of the buck circuit 200 through the primary coil of the transformer T1. The resistor R3 is connected between a first end and a second end of a secondary coil of the transformer T1. The first end of the secondary coil of the transformer T1 is connected to a non-inverting input terminal of the amplifier U1 through the resistor R4. The capacitor C6 is connected between the non-inverting input terminal of the amplifier U1 and ground. The capacitor C7 is connected between the non-inverting input terminal and an inverting input terminal of the amplifier U1. The resistor R5 is connected between the inverting input terminal and an output terminal of the amplifier U1. The output terminal of the amplifier U1 is connected to an inverting input terminal of the amplifier U3 through the resistor R6. The resistor R7 is connected between the inverting input terminal and an output terminal of the amplifier U3. The resistor R8 is connected between the inverting input terminal of the amplifier U1 and an inverting input terminal of the amplifier U2. The resistor R9 is connected between the inverting input terminal and an output terminal of the amplifier U2. The second end of the secondary coil of the transformer T1 is connected to a non-inverting input terminal of the amplifier U2 through the resistor R10. The capacitor C9 is connected between the non-inverting terminal of the amplifier U2 and ground. The capacitor C8 is connected between the inverting input terminal and the non-inverting input terminal of the amplifier U2. The output terminal of the amplifier U2 is connected to the non-inverting input terminal of the amplifier U3 through the resistor R11. The resistor R12 is connected between the non-inverting input terminal of the amplifier U3 and ground. The output terminal of the amplifier U3 is connected to an input terminal RA0 of the microcontroller U11. Ground terminals of the amplifiers U1-U3 are grounded. Voltage terminals of the amplifier U1-U3 are connected to a power source V2. In one embodiment, the power source V2 is a 12V power source, and the transformer T1 is a current collecting transformer.

The display unit 140 is connected to input/output (I/O) terminals RA2-RA5 and RC0-RC7 of the microcontroller U11.

In one embodiment, the output terminals RB4-RB7 of the microcontroller U11 have sixteen kinds of output. Each output can control a corresponding resistance of the digital regulation resistance U22 to be connected to the buck circuit 200. For example, the output terminals RB4-RB7 of the microcontroller U11 output signals “0000”, to direct the digital regulation resistance U22 to provide a 0.5Ω resistance to the buck circuit 200, wherein “0” indicates a low level signal. When the output terminals RB4-RB7 of the microcontroller U11 output signals “0001”, to direct the digital regulation resistance U22 to provide a 1Ω resistance to the buck circuit 200, wherein “1” indicates a high level signal.

In use, when the switch K1 is pressed to close, the microcontroller U11 is turned on. The output terminals RB4-RB7 of the microcontroller U11 output signals “0000” to the digital regulation resistance U22, to direct the digital regulation resistance U22 to provide a 0.5Ω resistance to the buck circuit 200. The PWM controller 20 outputs a PWM signal to the PWM driving unit 21, to turn the FETs Q1 and Q2 on or off. The voltage output terminal Vout outputs a voltage to other elements. At the same time, the voltage from the voltage output terminal Vout is provided to the primary coil of the transformer T1, and is also provided to the load 131. The voltage across the primary coil of the transformer T1 induces a current in the secondary coil of the transformer T1 and a voltage is maintained across the resistor R3, the induced current is amplified through the amplifiers U1-U3 and the output current of the amplifiers U1-U3 is provided to the microcontroller U11 through the input terminal RA0. The microcontroller U11 compares the amplified current with a preset current and directs the display unit 140 to display the 0.5Ω resistance. If the amplified current is less than the preset current, the output terminals RB4-RB7 of the microcontroller U11 output signals, such as “0001” to the digital regulation resistance U22, to direct the digital regulation resistance U22 to provide increased resistance, such as 1Ω resistance to the buck circuit 200, and the work theory is same as described. If the amplified current exceeds the preset current, the microcontroller U11 outputs no control signals to the digital regulation resistance U22. The PWM controller 20 will not output a PWM signal. The voltage output terminal Vout outputs no voltage. Thus, the last resistance displayed on the display unit 140 is an optimal overload protection for the buck circuit 200.

The measurement circuit 100 can obtain an overload protection optimal resistance of the buck circuit 200 by automatically connecting different resistances to the buck circuit 200. The measurement circuit 100 is simple and can save costs.

It is to be understood, however, that even though numerous characteristics and advantages of the disclosure have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A measurement circuit for overload protection in a buck circuit, the buck circuit comprising a pulse width modulation (PWM) controller and a voltage output terminal, the measurement circuit comprising:
a resistance setting circuit to connect different resistances to the PWM controller of the buck circuit;
a switch circuit to direct the measurement circuit on or off;
a current collection circuit to receive a voltage from the voltage output terminal of the buck circuit and transform the received voltage to current, and amplify the transformed current and output the amplified current to the resistance setting circuit, wherein the resistance setting circuit chooses a resistance through comparing the amplified current with a preset current; and
a display unit to display the chosen resistance.

2. The measurement circuit as claimed in claim 1, wherein the resistance setting circuit comprises a microcontroller, a digital regulation resistance, a first resistor, first to fifth capacitor, and a crystal oscillator, first to fourth input terminals of the digital regulation resistance are connected to first to fourth output terminals of the microcontroller, a clock terminal of the digital regulation resistance is connected to a fifth output terminal of the microcontroller, a data terminal of the digital regulation resistance is connected to a sixth output terminal of the microcontroller, a voltage terminal of the digital regulation resistance is connected to a first power source and connected to one terminal of the first capacitor, the other terminal of the first capacitor is grounded, first and second output terminals of the digital regulation resistance are connected to the PWM controller, a first voltage terminal of the microcontroller is connected to a second power source and connected to one terminal of the first resistor, the other terminal of the first resistor is connected to one terminal of the second capacitor, the other terminal of the second capacitor is grounded, one terminal of the third capacitor is connected to the first voltage terminal of the microcontroller and the other terminal of the third capacitor is grounded, a second voltage terminal of the microcontroller is connected to a node between the first resistor and the second capacitor, a first clock terminal of the microcontroller is grounded through the fourth capacitor, a second clock terminal of the microcontroller is grounded through the fifth capacitor, the crystal oscillator is connected between the first and second clock terminals.

3. The measurement circuit as claimed in claim 2, wherein the first power source is a 5 volt (V) power source.

4. The measurement circuit as claimed in claim 2, wherein the switch circuit comprises a second resistor and a switch, the first input terminal of the microcontroller is connected to the second power source through the second resistor and also grounded through the switch.

5. The measurement circuit as claimed in claim 4, wherein the current collection circuit comprises a transformer, a load, first to third amplifiers, third to twelfth resistors, and sixth to ninth capacitors, the load is connected to the voltage output terminal of the buck circuit through the primary coil of the transformer, the third resistor is connected between first and second ends of the secondary coil of the transformer, the first end of the secondary coil of the transformer is connected to a non-inverting input terminal of the first amplifier through the fourth resistor, the sixth capacitor is connected between the non-inverting input terminal of the first amplifier and ground, the seventh capacitor is connected between the non-inverting input terminal and an inverting input terminal of the first amplifier, the fifth resistor is connected between the inverting input terminal and an output terminal of the first amplifier, the output terminal of the first amplifier is connected to an inverting input terminal of the third amplifier through the sixth resistor, the seventh resistor is connected between the inverting input terminal and an output terminal of the third amplifier, the eighth resistor is connected between the inverting input terminal of the first amplifier and the inverting input terminal of the second amplifier, the ninth resistor is connected between the inverting input terminal and an output terminal of the second amplifier, the second end of the secondary coil of the transformer is connected to the non-inverting input terminal of the second amplifier through the tenth resistor, the ninth capacitor is connected between the non-inverting input terminal of the second amplifier and ground, the eighth capacitor is connected between the inverting input terminal and the non-inverting input terminal of the second amplifier, the output terminal of the second amplifier is connected to a non-inverting input terminal of the third amplifier through the eleventh resistor, the twelfth resistor is connected between the non-inverting input terminal of the third amplifier and ground, the output terminal of the third amplifier is connected to the second input terminal of the microcontroller, the voltage terminals of the first to the third amplifier are connected to a third power source.

6. The measurement circuit as claimed in claim 5, wherein the third power source is a 12V power source.

7. The measurement circuit as claimed in claim 5, wherein the transformer is a current collecting transformer.

8. The measurement circuit as claimed in claim 5, wherein the display unit is connected to first to twelfth input/output (I/O) terminals of the microcontroller.
